(19) United States
(12) Patent Application Publication
(10) Pub. No.: US 2016/0253742 A1
(43) Pub. Date: Sep. 1, 2016

(54) BREED-TARGETED ORDERING AND DELIVERY SYSTEM

(71) Applicants: Graham BOSHER, Surrey (GB); TAILSCO LIMITED, Surrey (GB)

(72) Inventor: GRAHAM BOSHER, Surrey (GB)

(21) Appl. No.: 15/078,054

(22) PCT Filed: Sep. 23, 2014
(86) PCT No.: PCT/GB2014/052885

§ 371 Date: Mar. 23, 2016

(30) Foreign Application Priority Data
Sep. 23, 2013 (GB) 1316846.3

(51) Int. Cl. G06Q 30/06

(52) U.S. Cl. CPC G06Q 30/0637

(57) ABSTRACT

Bulk delivery of pet-specific pet foods, via a courier service (30), is orchestrated by a server (18) responding to an order instruction (16) sent to the server (18) over a communication channel, such as established through a web browser session on a home computer (14). Control logic executed by the server interprets the order instruction and accesses a database (22) to select a species-targeted and, preferably, a breed-specific meal that is tailored to the customer's pet. Ultimate control of what pet food is finally delivered to the customer rests with the control logic in the server, although selection by the server is influenced by customer-stated pet information stored at customer registration or otherwise advised in the order instruction, specifically identified pet requirements, pet characteristics that are breed and animal specific and possibly, but certainly to a lesser extent, pet food blend availability. The server may also be configured to vary deliveries and particular bespoke meal content based on seasonal changes or the pet's change in dietary intake, such as with increasing age and hormonal imbalances arising with transitions between juvenile age and adulthood. The server includes control logic arranged to select, and then arranged to send with the pet food order, a measuring cup or tool that provides a precise measure of pet food; this avoids waste and overfeeding by ensuring that the delivered bulk package contains a near integral number of servings from the measure.

### CROSS-REFERENCE TO RELATED APPLICATIONS

This application is a national stage entry from International Application No. PCT/GB2015/052885, filed Sep. 23, 2014, and claims the benefit of prior application no. GB 1316846.3, filed Sep. 23, 2013, each of which is hereby incorporated herein by reference in its entirety.

### FIELD OF THE INVENTION

This invention relates, in general, to a breed-targeted ordering and delivery system and is particularly, but not exclusively applicable to a pet food ordering system that administers delivery of pet food (in bulk quantities) according to nutritional requirements of a breed of pet or characteristic of a particular pet, such as a Labrador dog or a Persian cat.

### SUMMARY OF THE PRIOR ART

Internet-based ordering systems are now becoming common place with respect to food ordering. Such systems allow a registered user to enter a bespoke retail website and then to identify and select foodstuffs or other commodities offered for sale by the retailer. The registered user selects the item by placing it in a “basket” and then stipulating a quantity to be purchased. After this interactive selection process, the registered user “checks out” by providing some form of payment information and delivery address, although certain applications pre-store payment information and permit a “one-click” purchase, such as offered by Amazon®.

Interactive sites on the internet also recommend or help users identify, for example, places to eat that satisfy particular human dietary requirements. The systems operate an interrogatory regime in which an on-line user is asked a series of questions that are refined in response to each previous question, i.e. the control algorithm running on the server drills down into increasing levels of detail so as to eventually provide a recommendation. This type of interrogatory approach requires time that people simply do not have, or otherwise do not wish to expend. Clearly, the recommendation leaves the final decision with the user.

Additionally, the ubiquitous nature of smartphones frequently means that, for example, restaurant recommendations (and indeed the original enquiry) are delivered (or initiated) through a mobile network, with delivery of the final recommendation requiring a stable communications path. With fading, multi-path interference and other forms of degradation, the length of time required by the practised interrogation regimes can result in the connection being lost before the final recommendation is delivered. This loss results in user frustration because individual data entry points are not stored at the server and the user is therefore required to re-enter data to questions that have already been asked. Servers in such interrogations systems are therefore inert in that they operate merely to present information that is indexed in response to “yes” or “no” responses to specific questions, e.g. “Do you want starch?” or “Are you gluten intolerant?”, or entered responses to instructions, e.g. “Check which restaurant types you wish to consider from the list of Chinese, Japanese, French, Italian, etc.”.

U.S. 2003/0208409-Mault describes a portable computing device that assists a person to locate a food retailer in view of a food preference of the person. A software application program is adapted to transmit the food preference and the location of the person to a remote computer system over a communication network, and to receive data from the remote computer to render, on a display, food retail locations and menu lists complying with the food preferences to the person. Mault sets out the deficiencies of the prior art as being an inability of a diner to locate “a restaurant that offers even one meal complying with [food allergy and diet restriction] requirements”, with acknowledge systems failing “to allow a person to obtain nutritional information of food available.

The computing device (such as a PDA) of Mault stores food preference data in memory and is configured to transmit the food preference, user identity and other data to other devices in communication range using a transceiver. Using an interactive but reactive platform based on dialogue, a restaurant computer responds by transmitting food item descriptions and associated nutritional data to the portable computing device. This means that a user can view food item descriptions and nutrition information on the display of the portable computing device, and restrict the display to that of food item descriptions having nutritional data compliant with the food preference. The restaurant computer can be further adapted to receive the food preference from the portable computer device, and to transmit only food item descriptions having nutritional data compliant with the food preference. Therefore, the user restricts display of food items that are displayed on their personal PDA, or the restaurant restricts the food items communicated to the PDA so as to be compliant with user preference that can be pre-stored in the PDA. After selecting one or more items, and reviewing nutritional information, the user can place an order with the restaurant for the food selected, with the Mault system further adapted to receive a payment authorisation from the user of the portable electronic device

U.S. 2003/0208409-Mault therefore suffers from several problems, including inefficiencies with data transfer in a non-predictive-based system that is reactive and entirely dependent on a multi-step process involving interaction/dialogue with a user.

U.S. 20070143172-Bhagechandani relates to the display of recommendations for restaurants; this is reflected in its abstract and especially its FIG. 5. System initialization obtains financial transaction from a variety of credit cards. A filtering stage generates a list a restaurants, with the subsequent processing stage generating a prioritised set of recommended restaurants Importantly, the system does nothing other than to display the prioritised set of recommended restaurants to each customer via an online billing statement. Bhagechandani makes no selection that results in the customer receiving anything, but rather just provides an online list that is seen by the user. The user then makes their own choice when visiting the restaurant. Indeed, the user's choice may not correspond with the prioritised list and could be entirely arbitrary and based on a whim of the user at the point in time when they make their decision. Furthermore, Bhagechandani contains no specific customer instruction, since its ranking of restaurants is based on collated financial transactions only.

U.S. 2005/0104730-Yang relates to a delivery and auto-receipt system supported by an improved mailbox. Yang addresses the issue of home absenteeism at the point of delivery of ready-to-eat frozen and pre-warmed foods bought online In Yang, an intelligent multifunction iBox^{TM} mailbox streamlines delivery operations and provides more security by providing a built-in camera that records time-point access to the iBox^{TM} mailbox. The iBox^{TM} mailbox supposedly stores and preserves delivered foods in a frozen or pre-warmed manner, thereby maintaining their original taste and freshness.

U.S. 2001/0027418-Johnson relates to a system and method for allowing on-line, real-time monitoring and control of inventory information. Inventory information may be monitored or displayed through a webpage or other user interface, wherein a web page displaying inventory information may allow users to view all available inventory, or to select portions of the available inventory through filtering.

U.S. 2010/0292998- Bodlaender makes a recommendation by locally displaying, printing or locally announcing a recipe and leaves the choice with the client. Bodlaender can substitute pre-programmed alternative ingredients into an original recipe, which substitution supposedly yields a recipe that is the same as the original. However, it is noted that any ingredient substitution is a material change, with any discernible change effects the dishes flavour or appearance. The approach in Bodlaender is akin to having someone order a Coca Cola® and then giving them a Pepsi® Cola to drink—the recipe has changed and the delivery drink is not the same as the one that was expected.

U.S. 2009/0055199-Yusuf is a way of keeping track of a dietary plan when shopping. Yusef (see abstract) just provides feedback and provides no delivery selection. Particularly, a user is provided with a running summary and is exposed to ongoing choice when shopping. Guidance is provided on a till receipt on the issue of what foodstuffs should be consumed to comply with the diet. Again, in Yusuf, control remains entirely with the user as to what is consumed.

U.S. 20020046060-Hoskyns is a system that transmits a meal plan to a user interface.

Evidently, the meal plan can be followed or can be ignored by the user, so the intelligence in Hoskyns makes no final decision and relies upon the user. Hoskyns is therefore interactive in that is doesn't make a final decision since requires interrogation of the user for modification of the meal plan.

With respect to pet food, Royal Canin® offers (through veterinary practices and pet food stockists) a range of pet food products that are presented as breed, animal-size, e.g. small, mini or giant, and activity (e.g. highly active) specific. Specifically, the so-called Breed Health Nutrition range provides a selection of the protein sources, unique ingredients and flavours, and tailor-made kibbles designed in their shape, texture and size to fit both different jaws and the dog's age. More information can be found at the website: http://www.royalcanin.co.uk/products/products/dog-products/breed-health-nutrition#sthash.9gvkQFHm.dpuf.

For dogs, the Breed Health Nutrition range by Royal Canin® is purchased in a fixed foil sacks of either 3 kg or 10 kg, with feeding instructions following a recommended amount presented in terms of an arbitrary “cup” or otherwise as a gram-specific daily quantities identified to the nearest gram. Catfood of the Breed Health Nutrition range is similarly packaged, with a recommended feeding quantity provided in grams per day. Such pet food is not only bulky, but it is relatively heavy. Pet food is also generally a regular purchase for households who own mammalian, generally carnivorous pets, especially dogs and cats. The bulkiness and weight of packaged pet food is furthermore frequently viewed as not being particularly conducive with general household shopping for foodstuffs and toiletries, so online ordering and delivery services—these are well known—alleviate the need to transport the relatively heavy and cumbersome pet food around the shop, from the shop into a car (or public transport) and then from the car (or bus stop) into the home.

Furthermore, the general feeding instructions that accompany pet foods frequently lead to over-feeding since the level of accuracy in portion management is seldom, if ever, followed (or even considered) by the human owner of the pet. Rather, a visual reckoning is employed in serving pet food, which visual reckoning is based in guesswork. This also can lead to waste and hygiene issues since the pet food can dry out (if not eaten) or can attract flies, especially if the pet food is a wet mix or otherwise contains protein or sugars.

### SUMMARY OF THE INVENTION

According to a first aspect of the present invention there is provided a computer-based pet food ordering and delivery system configured to determine and automatically select pet food to be assembled as a bulk order containing ingredients targeted to a specific pet associated with a specific customer, the computer-based ordering system containing: a server responsive to an order instruction originating from the specific customer and identifying the specific pet; and a database containing pet-related information cross-referenced to customer ownership and identifying stored pet characteristics, at least some of the pet characteristics supplied by customers and related to identified pets; wherein the server is configured to execute code that delivers server-identified ingredients selected finally by the server for delivery to the specific customer in the bulk order for that specific customer's specific pet, selection by the server being responsive to and influenced by the order instruction received by the server from the specific customer.

In a preferred embodiment the server is configured to vary automatically bulk order deliveries according to at least one of: seasonal changes affecting food consumption by specific breeds; increasing age of the specific pet identified in the order instruction; and hormonal imbalances arising in the specific animal with time.

Preferably, the server is configured to select a measuring tool to be dispatched with the bulk order, the measuring tool providing a precise measure of pet food for a meal.

Advantageously, the present invention provides an online delivery service that is pet (breed) specific and/or targeted to a specific creature. The system's backend server operates to select a pet food mixture that reflects pet characteristics for a particular breed, which order may be further tailored to an individual requirement for a pet over time. The system therefore provides an efficient way of delivering bulky and potentially heavy pet food, with the system optimizing nutritional or dietary content in a bespoke meal plan.

Once registration of a pet has occurred, the system is autonomous and provides for tailored variation in food intake and/or nutritional supplements to promote pet health. The pet's owner, i.e. the customer, is therefore left to enjoy the pet, rather than to concern themselves with selection from myriad of pet food products.

### BRIEF DESCRIPTION OF THE DRAWINGS

Exemplary embodiments of the present invention will now be described with reference to the accompanying drawings, in which:

FIG. 1 is a block diagram of an order placement and order delivery system according to a preferred embodiment of the present invention.

### DETAILED DESCRIPTION OF A PREFERRED EMBODIMENT

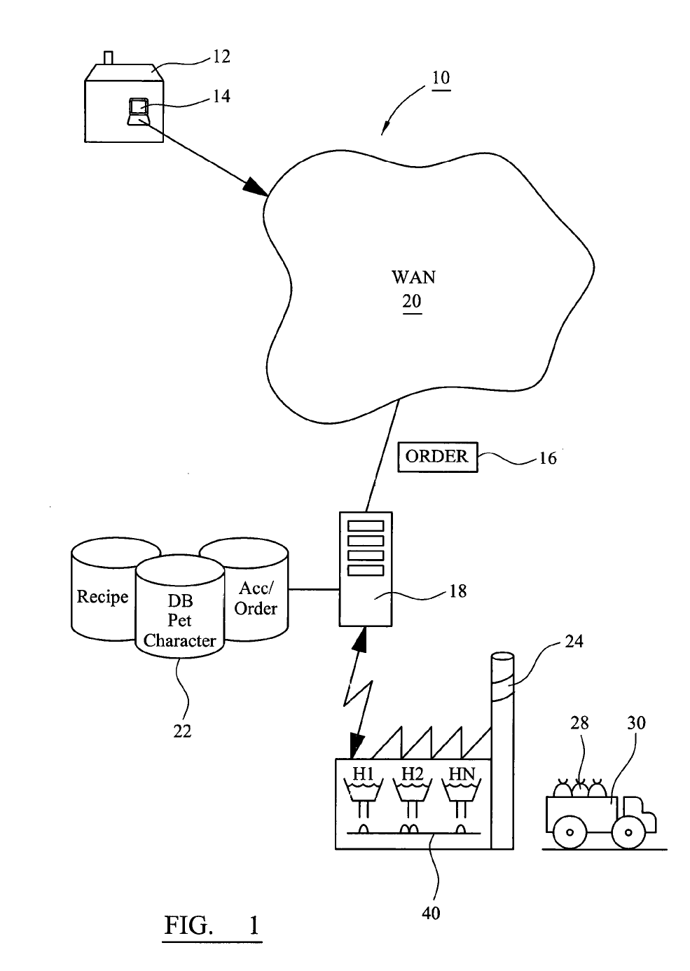

FIG. 1 is a block diagram of an order placement and order delivery system 10 according to a preferred embodiment of the present invention

The system 10 is a computer-based ordering and delivery system in which a customer 12 makes use of a computer 14 or the like (such as a smartphone) to register with and then place an order instruction 16 with a server 18 of a pet food supplier. Connection to the server 18 is via a wide areas network (“WAN”) 20, such as the internet or a cellular telecommunications network. Rather than making use of a computer-based system, it is also envisioned that the customer's order could be placed over some form of network, e.g. a telephone that supports voice recognition or which provides access to a computerized or human data entry clerk who/that in turn causes storage of appropriate data in an appropriate database 22.

Unless the context requires a more specific interpretation, the term “server” should be understood to include a cloud-computing environment or a distributed processing system.

The system 10 is geared to the provision of a subscription service for pet foods, and especially bulk pet foods (typically dry kibble or biscuits, but also wet meals) for dogs and cats. Of course, the principles described herein may be applied to other pets requiring targeted diets.

The server 18 is coupled to at least one database 22 that cross references customer profile details with customer payment and/or customer account details (preferably used to establish a subscription service) and pet data relating to the customers' pet(s). The database 22 further stores a record of pet-type (e.g. dog, cat, etc.) and optionally, but preferably, also stores at least one other pet characteristic reported by the customer and used by an order assembly algorithm (executed by the server 18) configured to arranged to construct and deliver a bespoke bulk pet food order for a specifically identified pet. Stored pet characteristics that influence the server-controlled production and delivery of multiple meals may include, for example, one or more of the following:
(i) breed of pet; and/or
(ii) customer-reported pet trait, such as activity (e.g. active or lethargic); and/or
(iii) perceived pet health; and/or
(iv) current veterinary treatment regimens; and/or
(v) restricted dietary plans; and/or
(vi) nutritional requirements for identified breeds; and/or
(vii) pet age; and/or
(viii) target weight either determined by the system (based on breed-identified target stored in the database) or specified by the customer; and/or
(ix) reported meal preferences or pet food dislikes noted by the customer; and/or
(x) current pet weight; and/or
(xi) current or previous foods delivered to the customer for the specific pet; and/or
(xii) known medical conditions of an identified pet as reported and stored in the database.

In designing a meal for the pet, besides the pet characteristics identified above, the server's control algorithm may furthermore be influenced by stipulated ratios between wet and dry food as reported by the customer for the specific pet.

The user may also provide an identifying image of the pet, such as in a jpeg file, which image is cross-referenced against the pet name and customer for storage in the database against the customer reference. In the production of a bespoke pet food order (described below in more detail), the server may access any stored image and control printing of that image on labelling or accompanying literature that is sent out with the pet food order. The jpeg file (or other suitable file format known to the skilled addressee) may itself be analysed by the server's control algorithm (having regard to an identified breed type and/or age) to assess the pet's state of health and particularly its comparative size/weight and/or body shape relative to a stored nominal reference for the breed. The server, having regard to this electronic assessment of physical characteristics, may be configured to auto select ingredient combinations or vitamin/nutritional supplement for assembly into the pet food order for the specific pet.

Order instructions 16 received by the server 18 are processed by control logic configured to execute a program of software instructions. Provided that the order instruction 16 includes completed data fields that identify the customer and their account (and does not include an update field), the order instruction 16 is either fulfilled by the server 18 (without further recourse to the customer), or otherwise taken as the start point for a server-initiated re-modelling of the order (which again requires no clarifying input from the customer in advance of shipment of the order to the customer). In other words, ultimate control of what pet food is finally delivered to the customer rests with the control logic in the server, although selection by the server will be influenced by customer-stated pet information, specifically identified pet requirements, pet characteristics and possibly, but certainly (to a lesser extent), pet food blend availability.

In the event that the order instruction includes an updated field or the server's databases are affected and thus altered by a specific notification (whether delivered electronically or otherwise), the database's data fields (such as the delivery address or one or more pet characteristics) relating to a specific customer or a specific pet owned by that customer are correspondingly modified to allow for future refinement of pet food orders for that customer.

Generally, the customer 12 will have an individual log-in that uniquely identifies the customer's address and billing information. Registration, ordering and updating are preferably achieved via an instantiated graphic user interface supported by the server and run on a web browser local to the customer. Registration details are recorded in the database 22, and can be accessed and updated by the customer to reflect changing pet food requirements. Once the payment mechanism is established, the control logic of the server 18 can oversee timely and repeat deliveries of pet food 28 through interaction with the pet food warehouse 24. Instructed deliveries sent from the warehouse 24 may make use of a national postal service or a courier service, e.g. a van-based road-delivery service 30.

The database 22 furthermore stores data relating to customer-stipulated order quantities (e.g. pet meals for twenty-eight days) and/or frequency of delivery for pet food orders. The frequency could be set as a one-off trial, or otherwise on a fixed day of the week or fixed day of each month, etc. The server's control algorithm dockets the delivery date of pet food to the customer and, based on this order-related information that is stored in accessible memory, ensures that auto replenishment of the order (or at least a prior notification warning the customer of pet food levels) is sent to the customer before pet food reserves at the customer are exhausted.

Upon receipt of an order instruction 16, a customer identity is retrieved from the order instruction and payment extracted from the customer account. The customer identity will typically be a unique user name, such as an email account, set-up by the customer at the point of registration, with the unique user name usually further protected by a password. If the customer has more than one pet, then the order instruction 16 also contains a pet identity. These pieces of information allow the server logic to recover the registered account for the customer and any pre-stored meal information and pet characteristics relating to the identified pet.

The database 22 further includes a recipe database that stores recognized relationships between pet characteristics and nutritional requirements for particular species and, especially, specific breeds within each species. The recipe database therefore marries ingredients used within a balanced meal for each breed or subset of a breed, such as young, old or pregnant pets. The size and shape of the kibble or biscuit may be selected by the server's control algorithm based on the breed and/or size of the pet based on pre-stored reference data. The stored recipes therefore represent professionally-optimised dietary meal plans for a species and, especially a breed of a species, with the professionally-optimised dietary meal plan varying the percentages of vitamins, minerals, fats, starches, carbohydrates and proteins formed into one or more of: kibble, a blend of kibble with other ingredients or kibbles; and compression molded or baked biscuits. Once the order is placed, the preferred software-implemented control system running on the server selects and causes assembly of meals for identified pets and then assembles batches of meals for dispatch to the customer.

In a particular embodiment, the professionally-optimised dietary meal plan may furthermore be adapted by the control algorithm, running on the server 18, to take into account the preferences of each unique pet, such as through the use of a particular flavouring or base protein, e.g. a type of fish compared to beef. The control algorithm therefore references customer relayed information, stored in the database 22, about the pet that for which the meals are being prepared.

The server 18 is therefore configured to control assembly of bespoke meals from the selection of ingredients or pre-assembled meal blends relevant to an expressly identified pet and reflecting reported (and stored) pet characteristics. The control logic executed by the server 18 is preferably configured to identify that similar species or breeds of pets are within a common household; this can be done by referring to the user's account. The control logic, during the assembly of a meal for a delivery, therefore preferably operates automatically to conclude that similar pets may, in fact, be sufficiently close so as to share the same meal plans without significantly or materially compromising pet well-being. The server's control logic can therefore make use of economies of scale in fulfilling orders for a specific customer having multiple similar (or, indeed, identical) pets.

The server 18 is in communication with an order assembly system 40 (which may include a robot, a conveyor and/or potentially multiple storage hoppers—H1, H2, H_{N}) in the warehouse 24. The server's control system is configured to instruct the order assembly system to assemble a bespoke order in response to interpretation (by the server's control algorithm) of each received order instruction 16 having regard to the stored pet characteristics of the pet as cross-referenced by or in the order instruction to a particular pet.

In a first embodiment, the bespoke meals may be pre-assembled from already assembled blends of ingredients that are recognised as providing a balanced meal for a particular breed of pet. In this way, the warehouse 24 may store pallets of pre-assembled recipes (say forty for a particular species), with the server's control algorithm providing an instruction (actioned by a robot or by a human being) that identifies a particular pallet as holding a suitable supply of pre-blended food that allows assembling of an order for (say, for example) a particular Alsatian dog. The server therefore provides a control instruction to the robot, or a printout or visual display to a manual worker, that orchestrates assembly of a plurality of meals from the identified pallet. Fulfilment of the order may therefore require shrink-wrapping or boxing of multiple pet food pouches (especially for wet blends), or pouring a measured volume or weight of pet food from a hopper into a box, bag or sack.

Moreover, in one embodiment, the order assembly system 40, in response to the server, is configured to select the pre-assembled meal that most closely fits the profile of the pet as recorded in the database 22 as pet characteristics.

The order assembly system 40 is therefore arranged to control packaging of multiple meals for courier delivery, with the order assembly system 40 configured to be typically responsible for: printing and affixing a postal label; optionally controlling the printing and application of a stored pet image to identify and target the pet for which the food is for; logging order completion in the database against the customer's registration; and/or arranging customer dispatch. The information printed under server control and supplied with the order optionally includes additional information or target information, including feeding instructions and/or the name, age and characteristics of the pet.

Of course, some or all of the assembly tasks in the various embodiments could be completed manually.

In a second embodiment, hoppers H1 to H_{N} may each hold only one particular ingredient of a multi-ingredient recipe, with the order assembly system 40 configured to obtain measured quantities of ingredients from each of multiple hoppers (or other dispensing equipment, such as weigh scales or spray applicators or other volumetric dosing apparatus) to assemble a pet food order for multiple meals. This approach requires greater system control and the typical use of multiple distributed processing sub-systems that respond to the server's instructions. This approach, however, provides a greater ability for the system to customize pet food orders for specifically identified pets having particular food likes and dislikes and/or particular nutritional and/or dietary requirements, with such requirement information stored in the database under specific pet characteristics against a specific registered customer account. Although it is preferably that the system is fully automated and under the control of a back office server at the warehouse, some or all of the assembly and delivery aspects of the preferred embodiment may be implemented manually (albeit that the assembly instruction is generated by the server's control algorithms that interpret the initial order instruction).

In terms of the packaging of multiple meals, a preferred embodiment saves packaging by assembling a measured quantity of ingredients into a single sack. The sack may therefore vary in weight from several hundred grams to several tens of kilograms, subject to the quantity ordered by the customer and the specific attributes of the pet, e.g. a full-grown female Bullmastiff in heat or other hormonal imbalances or changes arising with transitions between juvenile age and adulthood. The order assembly system 40 therefore precisely measures out a quantity of ingredients for a fixed number of meals for the pet.

One of the issues in providing a sack or bag of bespoke, pet-tailored ingredients is the possibility of excessive or under feeding. To address this issue, the server 18 includes software code that selects, and then arranged to send with the pet food order, a measuring cup or tool that provides a precise measure of pet food. For example, the measuring cup may indicate six level measures of a kibble, with this measure representing a precisely calculated amount of food for the specified pet. Indeed, supply and use of the measure mitigates the potential for over- or under-feeding and reduces waste since the amount of pet foot supplied in the tub, sack or bag (or other container) is a multiple of the database specified meal amount required for the specifically identified pet. The measuring cup or device may be realized by a flat-pack cardboard blank (or other material, such as plastic or pressed metal) that assemblies in to a measuring cone that, ideally, is specific and bespoke to the pet for which the bulk meals are assembled.

The flat-pack blank could, however, also include a graduated scale to allow for a certain degree of customer choice. Preferably, the measure is bespoke to avoid the chances of portion measurement error. Other forms of measuring device, including plastic molded scopes and the like, are possible for supply with the delivery. Again, the server's control software brings together the specific order for the pet and the measure required to administer accurately the meal plan; this may be an automated process or otherwise an instruction issued by the server (such as in a printout or on a display) and actioned manually. The server may, in fact, control the cutting of any bespoke measure. A label may be applied to the measuring tool, which label typically includes a pet name and selected characteristics and/or instructions for assembly of the measuring tool to the correct volume so as to ensure an accurate quantity of food is provided by the measuring tool having regard, for example, to the density of the supplied pet food. The densities of the pet food blend and/or ingredients are stored in the database to permit the server to generate an appropriate instruction concerning how the measuring tool is to be assembled to provide a fixed unitary measure.

Preferable, a small percentage variation, say +0.5% or less, may be factored into the automatically assembled delivery, with this over-supply negligible and deemed insufficient from the perspective of possible overfeeding.

The sever 18 of another embodiment may also be configured to effect a variation over time of delivered pet food based on pet characteristics. For example, the server's algorithm may automatically vary ingredient levels to address for seasonal changes and the pet's change in dietary intake. More protein, for example, may be provided in one reason relative to another given that eating habits and consumption may be affected by climate and seasonal changes. Once the customer is registered and the pet characteristic acquired and stored, the server's algorithm may be further arranged to modify automatically assembly meal regimes based on other factors, such as breeding cycles or increasing age. Consequently, the system of the preferred embodiment is able to addresses feeding and nutritional treatment of the pet without further reference to the customer. Of course, the system of the present invention may also respond to updates or instructions from the customer, e.g. a stored instruction to manage weight gain in a puppy or older dog. Again, the server is dynamic and makes the final choice with respect to assembly of bespoke meals for expressly identified pets or breeds of pets.

Within a multi-pet household, the system (i.e. control logic run by the server) recognises that pet sizes are different within the household and that consumption by each pet is correspondingly different. With the preferred dispatch to each household of pet foods in standardized packaging, such as multiples of 2 kg and 5 kg bags of kibble, efficiencies in delivery are obtained by having the server automatically vary repeat order delivery dates. To explain this, different bespoke pet food orders for different pets in the same household may result in an initial order to the customer containing 15 kg of one type of kibble for a first pet and then 7 kg of kibble for a second pet. The usage rates, as determined by the supplied measuring tool, may mean that the first 15 kg supply lasts twenty-six days and the second 7 kg supply lasts thirty-five days. In other words, one supply will need to be replenished sooner rather than the other. However, to benefit from scales in delivery, the system is automatically arranged to provision and ship a smaller amount of pet food to increase the customer's reserve for the second pet even though the order is predominantly designed to replenish the supply for the first pet. The delivery system is therefore dynamic in terms of its self-determined delivery date, with this shipping date and the amount shipped to the customer compensating for different pet food consumption rates by different pets in the same household. The server's control system is therefore arranged to optimize delivery weights for shipping efficiencies whilst ensuring that pet food reserves at the customer for each pet never run out.

In summary, the server 18 bases its decision for assembly on such things as: i) pet characteristics; and/or ii) specified dietary requirements or treatments; and/or iii) nutritional rules set for the breed of pet and/or the specific physical attributes of the pet.

With the order delivery system 40 responsive to the server 18, the system maintains an audit facility and can predict re-order of ingredients based on demand and supply. The server 18 therefore orchestrates the warehouse, updates the databases, undertakes stock control housekeeping, assembles bespoke bulk orders for identified pets, oversee payment authorization to a bank or credit agency and assigns scheduling and (optionally) tracking to each specific order.

As a further aspect to the server's assigned functionality, the pet characteristics are interpreted by the server to identify and suggest, such as in an email or other notification to the customer, products that are suitable for the customer's pet. For example, a variety of toys and treats may be identified by a vet as being suitable for a pet's development, with the databases holding a list of such toys and products. Based on order instructions and/or pet characteristics, the server 18 may select one of these toys or treats as being appropriate for a specific pet, whereafter the server 18 automatically compiles and sends a recommendation to a customer's email address (or the like). In this way, the system of this embodiment permits upselling of additional targeted products.

Unless specific arrangements are mutually exclusive with one another, the various embodiments described herein can be combined to enhance system functionality and/or to produce complementary functions in interpretation of an order instruction for the delivery of pet food. Such combinations will be readily appreciated by the skilled addressee given the totality of the foregoing description. Likewise, aspects of the preferred embodiments may be implemented in standalone arrangements where more limited functional arrangements are appropriate. Indeed, it will be understood that unless features in the particular preferred embodiments are expressly identified as incompatible with one another or the surrounding context implies that they are mutually exclusive and not readily combinable in a complementary and/or supportive sense, the totality of this disclosure contemplates and envisions that specific features of those complementary embodiments can be selectively combined to provide one or more comprehensive, but slightly different, technical solutions.

It will, of course, be appreciated that the above description has been given by way of example only and that modifications in detail may be made within the scope of the present invention. For example, while the preferred embodiment has been described with reference to the delivery of kibble, i.e. a dry mix of crumb or shaped biscuit, it will be appreciated that the invention may be applied to wet meals that may be sealed in individual one-use or multi-use pouches, with these potentially re-sealable pouches then boxed in larger cartons covering a stipulated period, e.g. a month.

1. A computer-based pet food ordering and delivery system configured to determine and automatically select pet food to be assembled as a bulk order containing ingredients targeted to a specific pet associated with a specific customer, the computer-based ordering system containing:
a server responsive to an order instruction originating from the specific customer and identifying the specific pet; and
a database containing pet-related information cross-referenced to customer ownership and identifying stored pet characteristics, at least some of the pet characteristics supplied by customers and related to identified pets;
wherein the server is configured to execute code that delivers server-identified ingredients selected finally by the server for delivery to the specific customer in the bulk order for that specific customer's specific pet, selection by the server being responsive to and influenced by the order instruction received by the server from the specific customer.

2. The computer-based pet food ordering and delivery system of claim 1, wherein the server is configured to vary automatically bulk order deliveries according to at least one of:
seasonal changes affecting food consumption by specific breeds;
increasing age of the specific pet identified in the order instruction; and
hormonal imbalances arising in the specific animal with time.

3. The computer-based pet food ordering and delivery system of claim 1 or 2, wherein the server is configured to select a measuring tool to be dispatched with the bulk order, the measuring tool providing a precise measure of pet food for a meal.

4. The computer-based pet food ordering and delivery system of claim 3, wherein the measuring tool is selected such as to provide a near integral number of meal servings from the bulk order dispatch to the specific customer for their specific pet.

5. The computer-based pet food ordering and delivery system of any preceding claim, wherein stored pet characteristics that influence the server-controlled production and delivery of multiple meals in the bulk order include one or more of the following:
i) identified breed of pet;
ii) customer-reported pet traits for the specific pet;
iii) reported pet health for the specific pet;
iv) current veterinary treatment regimens for the specific pet;
v) restricted dietary plans for the specific pet;
vi) nutritional requirements for the specific pet;
vii) pet age of the specific pet;
viii) target weight for the specific pet determined by one of the server and the specific customer;
ix) reported meal preferences for the specific pet;
x) pet food dislikes noted by the specific customer and related to the customer's specific pet; and/or
xi) current pet weight recorded against the specific pet;
xii) previous foods delivered to the specific customer for the specific pet; and
xiii) known medical conditions of the specific pet.
